(19) United States
(12) Patent Application Publication
(10) Pub. No.: US 2006/0104539 A1
(43) Pub. Date: May 18, 2006

(54) System for representing image of real object by using photographic images and method thereof

(76) Inventors: Hae-Dong Kim, Daejon (KR); Jin-Seo Kim, Daejon (KR); Sung-Ye Kim, Daejon (KR); Maeng-Sub Cho, Daejon (KR); Byoung-Tae Choi, Daejon (KR); Hyun-Bin Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/222,589

(22) Filed: Sep. 8, 2005

(30) Foreign Application Priority Data
Nov. 16, 2004 (KR) 10-2004-0093712

(51) Int. Cl. G06K 9/36

(52) U.S. Cl. 382/276; 382/254

(57) ABSTRACT

A system for image representation of a real object by using photographic images and a method thereof are disclosed. The system includes: a characterization unit of an image sensing device for extracting characteristics of an image sensing device to be used to obtain photographs of a target object; a characterization unit of an object for obtaining photographs of the target object by using the image sensing device and extracting characteristics of the target object by using the obtained photographs; and an image reproduction unit for reproducing photorealistic images by reinterpreting the extracted characteristics from the characterization unit of an object to be suitable to conditions of expressing the target object.

### FIELD OF THE INVENTION

The present invention relates to a system for image representation of a real object using photographic images and a method thereof; and, more particularly, to a system for representing an image of a real object by using photographic images and extracting characteristics of a device collecting target object characteristics data, obtaining photographs of the target object by using the device, extracting characteristics of the target object though analyzing, and reproducing photorealistic images and a method thereof.

### DESCRIPTION OF RELATED ARTS

A term ‘image’ denotes a digital image or image data, and the image is classified into a photograph created by an image sensing apparatus and a photorealistic image created by a simulation result.

The photograph is a data set visible to human's sight by converting light energy to the visible data set using an image sensing apparatus. That is, the light energy radiated from a light source is reflected from a target object, and the reflected light energy is expressed into visible shape by converting the reflected light energy to visible data through the image sensing apparatus. The photorealistic image is produced by the present invention (refer to FIG. 3). That is, the present invention is a system and a method for producing the photorealistic image suitable to new environment based on photographs of a target object.

Conventionally, in order to produce the photorealistic image of an object, an experienced person draws the object by using a painting system, or repeatedly performs mathematical calculation for realistic representation of the object based on the reflective characteristics rule by using an image synthesis system. Therefore, it takes long processing time to produce the photorealistic image. The reason to take such a long processing time is that the photorealistic image is produced by repeated retouching based on a person's experience or sense of beauty because there is no knowledge of a light environment influencing the color and reflection characteristics of the object.

However, if it is understood how light sources are distributed to the environment and how the lights are reflected from the object, the color of the object can be calculated mathematically.

Generally, the distribution of a light is expressed by a spectral power distribution function, and reflective characteristics of an object are expressed by bi-directional reflectance distribution function (BRDF). The real light source is irregularly radiated according to time, voltage or environment, but the variation of the light is not large enough for a person to recognize the color variation of an object in usual environments. That is, spectral characteristics of light can be defined by one time measurement when it is used for photorealistic images such as general movie or advertisement. However, the reflection characteristics of an object can be mathematically expressed by using a four-dimensional function BRDF (Θᵢ, φᵢ, θᵣ, φᵣ) expressed as the ratio between a ray of incident light source from random direction on a hemisphere and that of reflected energy to random direction. If the reflection characteristics of an object are measured based on the BRDF in a unit of 5 degree, 1,679,616 times of measurements must be performed (1,679,616={90/5*360/5}²). That is, although a unit angle is reduced to ½, the number of measurements increases to 16 times.

However, by using a region based image sensing apparatus the result of detailed measurements less than 5 degree can be obtained according to the resolution of the sensing apparatus. If the region based apparatus is used, we can take accurate measurement without degrading precision of reflection characteristics calculation by controlling the number of measurement times based on a general theory and the characteristics of the apparatus.

Conventionally, the reflection characteristics of an object can be calculated by measuring reflective energy from all directions using an optical mirror or an optical lens. However, that method does not fully consider various spectrum characteristics and diverse geometric characteristics of a target object's surface, such as a scratch or a curve, cannot be accurately reflected on a photorealistic image.

Furthermore, the surface characteristics of an object are reproduced by using a texture map in another conventional technology. However, there is a limitation to reproduce images about all reflected type of the object because of insufficient information about the general reflection characteristics of the object's surface.

### SUMMARY OF THE INVENTION

It is, therefore, an object of the present invention to provide a system for representing images of a real object and a method thereof. The system uses their photographic images to extract the characteristics of a target object and generates the photorealistic images based on the extracted characteristics

In accordance with an aspect of the present invention, there is provided a system for image representation of an object using photographs, the system including: a characterization unit of an image sensing device for extracting the characteristics of the image sensing device to obtain photographs of a target object; a characterization unit of an object for extracting optical characteristics of the object such as reflectivity and smoothness and so on by analyzing the photographs of the target object acquired by the image sensing device; and an image reproduction unit for reproducing photorealistic images to be suitable to the conditions of expressing the target object by reinterpreting its extracted characteristics.

In accordance with another aspect of the present invention, there is provided a method for image representation of an object by using photographs, the method including the steps of: a) extracting the characteristics of the image sensing device to obtain the photographs of the target object; b) extracting the characteristics of the target object by analyzing the photographs based on the extracted characteristics of the image sensing device and the obtained environment information; and c) reproducing photorealistic images to be suitable to new representation environments according to the extracted characteristics of the object.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram illustrating a system for image representation of an object in accordance with a preferred embodiment of the present invention;

FIG. 2 is a flowchart showing a method for image representation of an object in accordance with a preferred embodiment of the present invention;

FIGS. 3A and 3B are a flowchart and a graph for explaining the basic procedure of a system for the image representation of an object in accordance with a preferred embodiment of the present invention;

FIG. 4 is a flowchart showing a process of extracting an image sensing device characteristics in a method for image representation of an object in accordance with a preferred embodiment of the present invention;

FIG. 5 is a flowchart showing a process of characterizing an image sensing device in a method for image representation of an object shown in FIG. 4;

FIG. 6 is a flowchart showing operations of the characterization unit of the object in a method for image representation of an object in accordance with a preferred embodiment of the present invention;

FIG. 7 is a flowchart showing processes of analyzing the photographs of the object, extracting the object characteristics and storing the information in a method for image representation of an object in accordance with a preferred embodiment of the present invention;

FIG. 8 is a flowchart showing a process of reproducing photorealistic images of the object in a method for image representation of an object in accordance with a preferred embodiment of the present invention; and

FIG. 9 is a flowchart showing a process of reproducing images in FIG. 8.

### DETAILED DESCRIPTION OF THE INVENTION

Hereinafter, a system for representing an image of a real object by using their photographic images and a method thereof will be described in more detail with reference to the accompanying drawings.

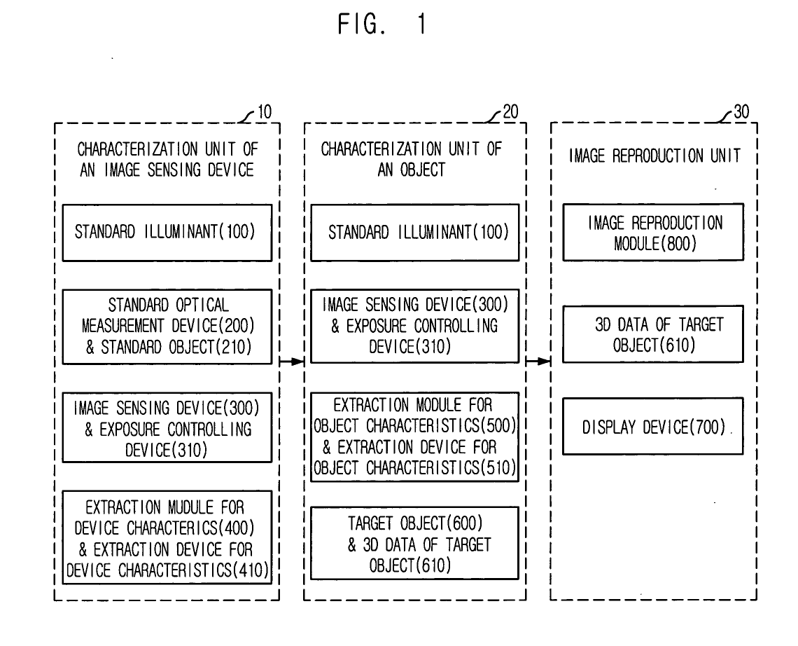

FIG. 1 is a block diagram illustrating a system for image representation of an object in accordance with a preferred embodiment of the present invention.

As shown in FIG. 1, the system for image representation of an object according to the present embodiment includes: a characterization unit of an image sensing device 10 for extracting characteristics of the image sensing device to obtain photographs of a target object; a characterization unit of an object 20 for extracting characteristics of the target object based on the extracted characteristics of the image sensing device; and an image reproduction unit 30 for reproducing photorealistic images by reinterpreting the extracted characteristics of the target object to be accurately suitable to desired conditions.

Hereinafter, the system for image representation of an object according to the present invention will be explained in detail.

That is, the system for image representation of an object according to the present embodiment includes: a standard illuminant 100 for lighting up an object, a standard optical measurement device 200 which is a reference for optical measurement; a standard object 210 having a well-known reflective rate and standard color; an image sensing device 300 and an exposure controlling device 310 for obtaining photographs of a target object; an extraction device for device characteristics 410 supplementarily provided to extract standardized device characteristics; a extraction module for device characteristics 400 for extracting the characteristics of the device; an extraction device for object characteristics 510 supplementarily provided to extract standardized object characteristics; an extraction module for object characteristics 500 for extracting the characteristics of the target object; an target object 600 which is reproduced; a 3D data 610 which is three-dimensional data of the target object; and a display device 700 and an image reproduction module 800 for displaying reproduced images.

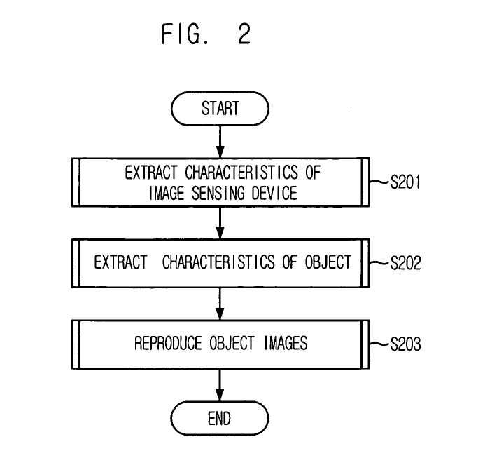

FIG. 2 is a flowchart showing a method for image representation of an object in accordance with a preferred embodiment of the present invention.

As shown in FIG. 2, the characteristics of an image sensing device are extracted to obtain photographs of a target image at step S201. The characteristics of the target image are extracted by analyzing the extracted image sensing device characteristics and obtained environment information at step S202. When new object reproducing environment is provided, the generated photorealistic images based on the extracted object characteristics are reproduced on a display device at step S203.

In the step S201, the characteristics of the image sensing device 300 are extracted by identifying the location of the standard optical measurement device 200 with that of the image sensing device 300 for providing identical condition to next measurements.

In the step S202, the standard illuminant 100 and the image sensing device 300 are arranged with a defined formation for extracting characteristics of an object based on the photographs of the object.

Also, in the step S203, the display device 700 can be controlled to display images to be closed to be seen by human eyes.

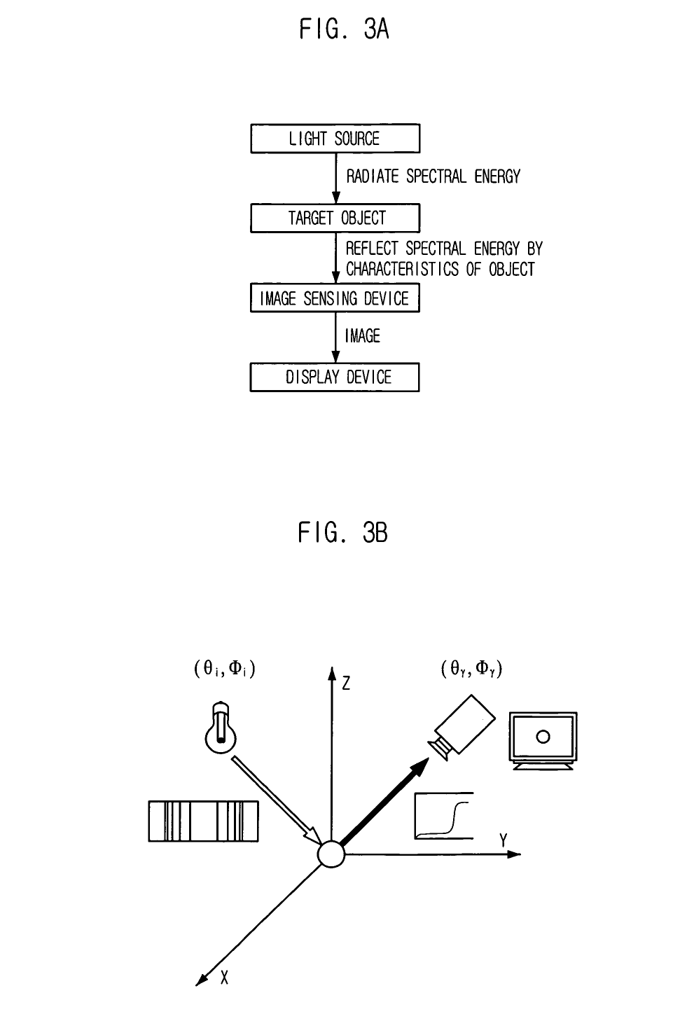

FIGS. 3A and 3B are a flowchart and a graph for explaining the basic procedure of a system for image reproduction of an object in accordance with a preferred embodiment of the present invention.

As shown in FIG. 3A, a spectral energy is radiated from an illuminant and spreads to surroundings. A portion of the spread spectral energy is reflected from an object to generate a spectral reflection according to the reflection characteristics and geometric configuration of an object. A portion of the reflected spectral energy is obtained by an image sensing device. The image sensing device generates a digital image based on the reflected spectral energy obtained, and the digital image is displayed on the display device.

FIG. 3B is a view for visually expressing FIG. 3A. As shown, a radiated light in random incidence angle of (θᵢ,φᵢ) hits to an object and a portion of the radiated light is reflected with a random reflection angle of (θᵣ,φᵣ). The reflected light is obtained by the image sensing device and displayed on the display device.

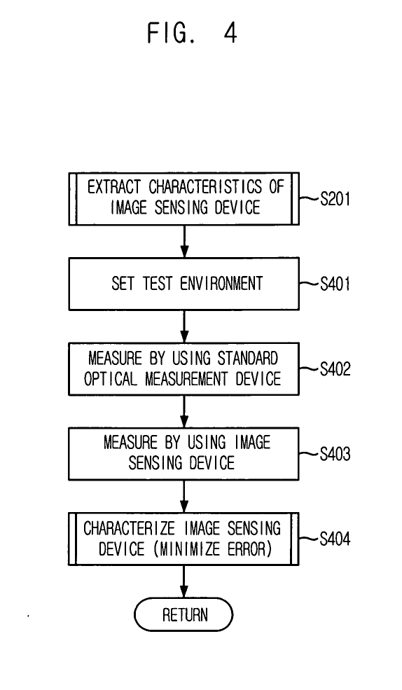

Hereinafter, operations of the system for image representation of an object according to the present embodiment will be explained in detail with reference to FIGS. 4 to 9.

FIG. 4 is a flowchart showing a process of extracting an image sensing device characteristics in a method for image representation of an object in accordance with a preferred embodiment of the present invention.

Referring to FIG. 4, the spectrum information of the standard illuminate 100 is initially obtained, and a test environment is set by locating the standard optical measurement device 200 and the image sensing device 300 for the standard object 210 to be optimally shown from the standard illuminant 100 by using the extraction device for device characteristics 410 at step S401. Herein, the extraction device for device characteristics 410 is a supplementary device for providing identical test condition to later tests by not changing locations of the standard optical measurement device 200 and the image sensing device 300. That is, the extraction device for device characteristics 410 is not a necessary device for extracting characteristics of the image sensing device.

After setting the test condition, the standard object is measured by using the standard optical measurement device 400 in order to define a reference at step S402, and photographs of the standard object are obtained by the image sensing device at step S403. After obtaining photographs, the characteristics of the image sensing device 300 is obtained by analyzing the obtained photographs and performing the characterization of the image sensing device to minimize difference between output data of the image sensing device 300 and the simulation result for a model of image sensing device at step S404.

Therefore, the characterization unit of an image sensing device 10 extracts and uses the characteristics of the device obtaining region based data by comparing with a conventional standard device obtaining point based data having well-known optical characteristics. Accordingly, the characterization unit of an image sensing device 10 according to the present invention can efficiently acquire data, can be implemented to a conventional R G B system, can be expanded to a wider channel by obtaining much more data, and can accurately compute a bi-directional reflectance distribution function (BRDF) value by using multi-spectral information.

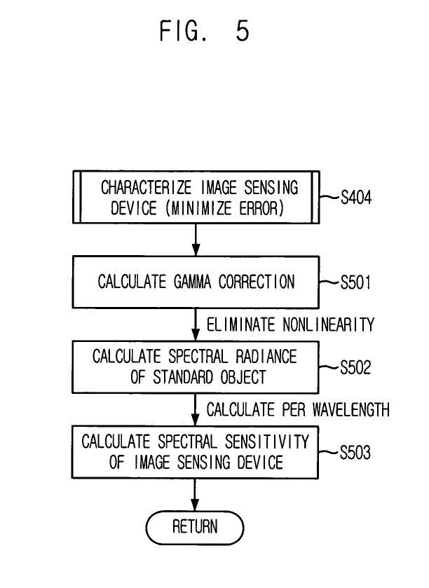

FIG. 5 is a flowchart showing a process of characterizing an image sensing device in a method for image representation of an image shown in FIG. 4.

The most general model of an image sensing device is shown in below Eq. 1.

$$\begin{matrix}{t}_{i} = F ( {\int }_{{λ}_{min}}^{{λ}_{max}} {s}_{i} ( λ ) \cdot L ( λ ) \cdot r ( λ ) ⅆ λ + {ξ}_{i} ) \\ - {t}_{i} \text{:} final sensor output signal \\ - F ( \cdot ) \text{:} gamma correction \\ - {s}_{i} ( λ ) \text{:} total sensor spectral sensitivity \\ - L ( λ ) \text{:} spectral radiance of illuminant \\ - r ( λ ) \text{:} spectral reflectance of object surface \\ - {ξ}_{i} \text{:} noise property \\ - i \text{:} channel\end{matrix} \qquad Eq . 1$$

In Eq. 1, the characteristics of the image sensing device is modeled as a sᵢ(λ). That is, sᵢ(λ) is found by minimizing a difference between a result value tᵢ of the image sensing device 300 and a simulation result of the model

$$( F ( {\int }_{{λ}_{min}}^{{λ}_{max}} {s}_{i} ( λ ) \cdot L ( λ ) \cdot r ( λ ) ⅆ λ + {ξ}_{i} ) ) .$$

Accordingly, a gamma correction is performed for the simulation result to have non-linearity at step S501. Spectral radiances L(λ) of the standard object are calculated per wavelengths by using a reflective rate r(λ) between the light source L(λ) and the standard object at step S502. In order to minimize the difference, the spectral sensitivity sᵢ(λ) of the image sensing device is calculated at step S503.

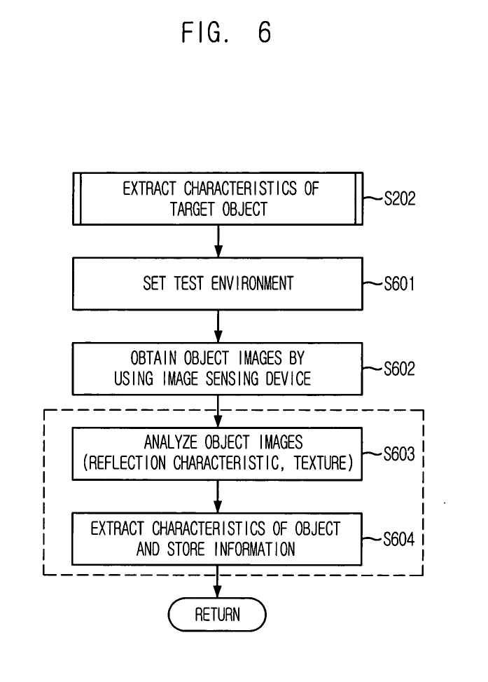

FIG. 6 is a flowchart showing operations of the characterization unit 20 of an object in a method for image representation of an object in accordance with a preferred embodiment of the present invention.

As shown in FIG. 6, a test environment is set by locating the standard illuminant 100 and the image sensing device 300 with a target object 600 as the center on a random location of a hemisphere at step S601. The extraction device for object characteristics 510 is a supplementary device for arranging the standard illuminant 100 and the image sensing device 300 to be a defined formation on the hemisphere. That is, the extraction device for object characteristics 510 is not a necessary device.

After setting the test environment, photographs of the target object are obtained by using the image sensing device 300 at step S602. During obtaining the photographs, the exposure controlling device 310 is used for controlling an exposure speed of the image sensing device 300 for effectively obtaining necessary data.

After obtaining the photographs, the BRDF value of the target object is calculated, and the photographs are analyzed to form map data by separating images to diffuse reflection and specular reflection at step S603. The characteristics database of the object is built to store the information of the interpreted results which is formed from the extracted characteristics of the object at step S604. The characteristics database may store BRDF data values without modification or the parameters of a selected BRDF model such as Phong, Blinn, Torrance-Sparrow similar to the characteristics of the object.

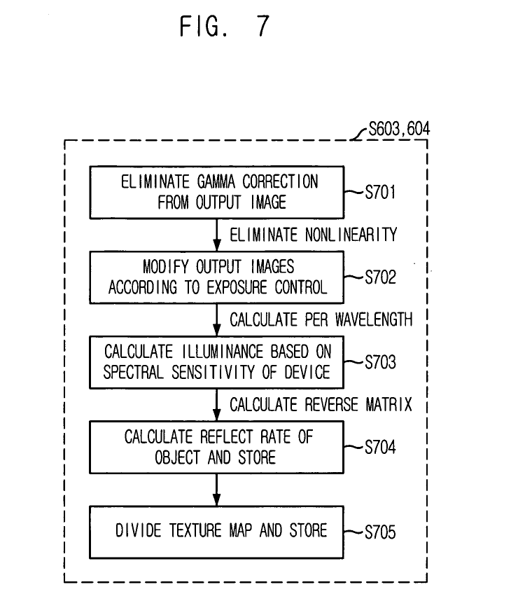

FIG. 7 is a flowchart showing processes of analyzing the photographs of the object, extracting the object characteristics and storing the information in a method for image representation of an object in accordance with a preferred embodiment of the present invention. That is, FIG. 7 shows the step 603 for analyzing the photographs of the object, and the step 604 for extracting the object characteristics and storing the information in FIG. 6.

As shown in FIG. 7, image data are linearized by eliminating a gamma correction portion from output images, the photographs of the object, of the image sensing device 300 which is known by Eq. 1 at step S701. The image data are modified according to the exposure control at step S702, and the illuminance of incident light is calculated by considering the extracted characteristics value sᵢ(λ) from the characterization unit of an image sensing device 10 at step S703. And, the reflective rate r(λ) is calculated and stored by applying various independent image data at step S704, and the images are stored as texture maps by classifying the images to diffuse reflection and specular reflection.

In case of general R G B system, R G B reflectivity (rᵣ,r_{g},r_{b}) can be calculated by dividing an output value tᵢ of the image sensing device 300 by the calculated illuminant value based on a device spectral sensitivity.

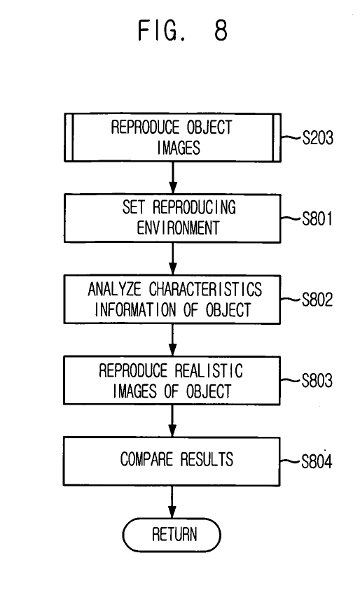

FIG. 8 is a flowchart showing a process of reproducing photorealistic images of the object in a method for image representation of an object in accordance with a preferred embodiment of the present invention. That is, FIG. 8 shows operations of the image reproduction unit 30.

As shown in FIG. 8, an image reproducing environment of the target object 600 is set based on newly given virtual light source information and the conditions of the image sensing device 300 such as an exposure level, location and direction at step S801.

After setting, object characteristics information is extracted and reinterpreted to be suitable to the new environment at step S802, and the object is reproduced at step S803. In order to know the difference between a simulation result of the target object and a result obtained from the image sensing device 300, the results are compared at step S804.

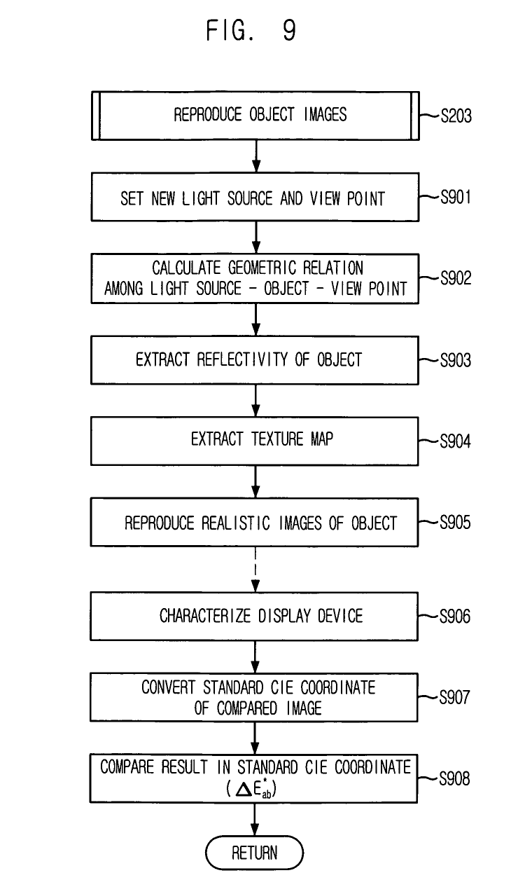

FIG. 9 is a flowchart showing a process of image reproduction in FIG. 8.

As shown in FIG. 9, an environment is set according to new illuminant and a view at step S901. The step S901 is equivalent to the step 801 in FIG. 8. After then, a geometric calibration is performed for calculating a geometric relation between illuminant-object-view at step S902. And, object reflectivity is extracted to be suitable to corresponding rendering environment at step S903.

Then, a corresponding texture map is extracted at step S904, and an object is reproduced according to general graphic rendering process at step S905.

As additional processes, the display device may be set to display the images of the object to be close to be seen by human eyes. That is, the display device is characterized at step S906 and the images to be compared are transformed to a standard CIE coordinate at step 907, and errors (ΔE*_{ab}) of the images within the standard CIE coordinate are calculated at step S908.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

As described above, in the present invention, data of a predetermined area are processed at once by obtaining original data. Therefore, data can be quickly processed in the present invention compared to a conventional point based optical device. Also, by using standardized measurement equipment, test errors can be reduced in the present invention. Furthermore, by obtaining a constant reflectivity according to a light source, synthesis images identical to a real object can be generated based on characteristics of new provided light source.

Accordingly, the system for image representation of an image according to the present invention can generate photorealistic images similar to a real target object although a bad luminance condition for photographing is provided and the target object is located at a bad environment for photographing. Therefore, the system for image representation of an image can be used for producing a movie or a commercial film requiring a realistic reproducing.

The present invention contains subject matter related to Korean patent application No. KR 2004-0093712, filed in the Korean patent office on Nov. 16, 2004, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

What is claimed is:

1. A system for image representation of an object using photographs of the object, the system comprising:
a characterization unit of an image sensing device for extracting characteristics of an image sensing device to be used to obtain photographs of a target object;
a characterization unit of an object for obtaining photographs of the target object by using the image sensing device, and extracting characteristics of the target object by using the obtained photographs; and
an image reproduction unit for reproducing photorealistic images by reinterpreting the extracted characteristics from the characterization unit of an object to be suitable to conditions of expressing the target object.

2. The system as recited in claim 1, wherein the characterization means of the image sensing device extracts characteristics of the device capable of obtaining region based data by using a standard device capable of point based data and having well-know characteristics, applies the extracted characteristics to a R G B system, expands to wider channel by obtaining more data, and increases accuracy of calculating BRDF value of the target object by using multi-spectral information.

3. The system as recited in claim 1, wherein the characterization means of the image sensing device eliminates non-linearity by calculating gamma correction to have linearity, calculates spectral radiation luminance of a standard object by using luminance L(λ) of a light source and reflectivity r(λ) of the standard object, and finds a spectral sensitivity Sᵢ(λ) of the image sensing device based on an equation to minimize a difference between a result value tᵢ of the image sensing device and a result of a simulation
$$( F ( {\int }_{{λ}_{min}}^{{λ}_{max}} {s}_{i} ( λ ) \cdot L ( λ ) \cdot r ( λ ) ⅆ λ + {ξ}_{i} ) ) ,$$
wherein the equation is expressed as:
$$\begin{matrix}{t}_{i} = F ( {\int }_{{λ}_{min}}^{{λ}_{max}} {s}_{i} ( λ ) \cdot L ( λ ) \cdot r ( λ ) ⅆ λ + {ξ}_{i} ) \\ - {t}_{i} \text{:} final sensor output signal \\ - F ( \cdot ) \text{:} gamma correction \\ - {s}_{i} ( λ ) \text{:} total sensor spectral sensitivity \\ - L ( λ ) \text{:} spectral radiance of illuminant \\ - r ( λ ) \text{:} spectral reflectance of object surface \\ - {ξ}_{i} \text{:} noise property \\ - i \text{:} channel\end{matrix}$$

4. The system as recited in claim 1, wherein characterization means of the object obtains necessary data by using an exposure controlling device of the image sensing device, linearizes image data by eliminating a gamma correction portion of the image sensing device from an output image, calculates luminance of an incident light by using the extracted characteristics Sᵢ(λ), and builds characteristics database of an object based on bi-directional reflectance distribution function (BRDF) values and maps data having diffuse reflection characteristics and specular reflection characteristics classified from an image, and a R G B system calculates R G B reflectivity (rᵣ,r_{g},r_{b}) by dividing the output value tᵢ of the image sensing device by a spectral sensitivity calculated based on the calculated luminance.

5. The system as recited in claim 1, wherein the image reproduction means includes: a setting function for setting new light source and view points of new environment; a geometric calibration function for calculating a geometric relation between light source—object—view point; an extracting function for finding a reflectivity of an object to be suitable to a rendering environment; and a reproduction function for realistically reproducing an object after extracting corresponding texture map.

6. A method for image representation of an object by using photographs of the object, the method comprising the steps of:
a) extracting characteristics of an image sensing device to be used to obtain photographs of a target object;
b) extracting characteristics of the target object by analyzing the extracted characteristics of the image sensing device and the obtained environment information; and
c) reproducing photorealistic images to be suitable to new object representation environment according to the extracted characteristics of the object.

7. The method as recited in claim 6, wherein the step a) includes the steps of:
a-1) initializing spectral information of a standard light source, and locating a standard optical measurement device and an image sensing device for a standard object to be optimally seen from the standard light source;
a-2) measuring the standard object by using the standard optical measurement device;
a-3) obtaining a photograph of the standard object based on the measured standard object; and
a-4) obtaining characteristics of the image sensing device by minimizing a difference between the output data value of the image sensing device and a simulation result through a model of the device.

8. The method as recited in claim 7, wherein in the step a-4), non-linearity is eliminated by calculating gamma correction to have linearity, spectral radiation luminance of a standard object is calculated by using luminance L(λ) of a light source and reflectivity r(λ) of the standard object, and a spectral sensitivity Sᵢ(λ) of the image sensing device is calculated based on an equation to minimize a difference between a result value tᵢ of the image sensing device and a result of a simulation
$$( F ( {\int }_{λ min}^{λ max} {s}_{i} ( λ ) \cdot L ( λ ) \cdot r ( λ ) ⅆ λ + {ξ}_{i} ) ) ,$$
wherein the equation is expressed as:
$$\begin{matrix}{t}_{i} = F ( {\int }_{{λ}_{min}}^{{λ}_{max}} {s}_{i} ( λ ) \cdot L ( λ ) \cdot r ( λ ) ⅆ λ + {ξ}_{i} ) \\ - {t}_{i} \text{:} final sensor output signal \\ - F ( \cdot ) \text{:} gamma correction \\ - {s}_{i} ( λ ) \text{:} total sensor spectral sensitivity \\ - L ( λ ) \text{:} spectral radiance of illuminant \\ - r ( λ ) \text{:} spectral reflectance of object surface \\ - {ξ}_{i} \text{:} noise property \\ - i \text{:} channel\end{matrix}$$

9. The method as recited in claim 6, wherein in the step a), the characteristics are extracted by locating the standard optical measurement device and the image sensing device not to be moved for providing constant test condition for later tests.

10. The method as recited in claim 9, wherein the step b) includes the steps of:
b-1) locating the standard light source and the image sensing device with the target object as a center at predetermined locations on a hemisphere;
b-2) obtaining necessary data by using an exposure controlling device of the image sensing device to obtain photographic images of the target object;
b-3) calculating bi-directional reflectance distribution function (BRDF) values of the target object by analyzing the obtained photographic images to form map data by classifying the obtained image into diffuse reflection characteristics and specular reflection characteristics; and
b-4) building the characteristics database of the object by storing the information of the interpreted results which is formed from the extracted characteristics of the object.

11. The method as recited in claim 10, wherein the characteristics database of the object stores BRDF data values or the parameters of a selected BRDF model such as Phong, Blinn, Torrance-Sparrow similar to the characteristics of the object.

12. The method as recited in claim 10, wherein in the step b) necessary data are obtained by using an exposure controlling device of the image sensing device, image data are linearized by eliminating a gamma correction portion of the image sensing device from an output image, luminance of an incident light is calculated by using the extracted characteristics Sᵢ(λ), and characteristics database of an object is built based on bi-directional reflectance distribution function (BRDF) values, map data having diffuse reflection characteristics and specular reflection characteristics classified from the image, and a R G B system calculates R G B reflectivity (rᵣ,r_{g},r_{b}) by dividing the output value tᵢ of the image sensing device by a spectral sensitivity calculated based on the calculated luminance.

13. The method as recited in claim 12, wherein the step c) includes the steps of:
c-1) setting new light source and view points of new environment;
c-2) calculating a geometric relation between light source—object—view point;
c-4) extracting reflectivity of an object to be suitable to a rendering environment; and
c-5) realistically reproducing an object after extracting corresponding texture map.

14. The method as recited in claim 13, wherein in the step c) further includes: c-6), after the characterization of the display device, transforming images to be compared to a standard CIE coordinate, and calculating errors (ΔE*_{ab}) of the images within the standard CIE coordinate for the display device to reproduce images of the target object to be close to be seen by human eyes.
